(19) United States
(12) Patent Application Publication
(10) Pub. No.: US 2026/0147245 A1
(43) Pub. Date: May 28, 2026

(54) LIGHT INDUCED TRANSPARENT ELECTRODE FOR ADDITIVE MANUFACTURING

(71) Applicant: Seurat Technologies, Inc., Willmington, MA (US)

(72) Inventor: Selim Elhadj, Lexington, MA (US)

(21) Appl. No.: 18/962,661

(22) Filed: Nov. 27, 2024

(51) Int. Cl. G02F 1/1343; B22F 12/41; B22F 12/90; B33Y 30/00; G02F 1/1335

(52) U.S. Cl. CPC G02F 1/13439; B22F 12/41; B33Y 30/00; G02F 1/133502; B22F 12/90

(57) ABSTRACT

A tunable and reconfigurable transparent electrode for a light valve includes a semi-insulating material substrate having an electrically insulating dark region and a shallow electrically conductive region. The light valve further has a transparent and conductive contact supported by the semi-insulating material substrate, wherein charged carriers are generated optically in response to incident light passing through the transparent and conductive contact and into the semi-insulating material substrate.

### TECHNICAL FIELD

The present disclosure generally relates to a system and method for improved spatial light modulators useful in additive manufacturing. In some embodiments, spatial light modulators can include a light valve system with transparent electrodes.

### BACKGROUND

An image created by an electrically addressed spatial light modulator can be created and changed electronically, as in most electronic displays. Light modulators can be used to completely or partially block, redirect, or modulate laser light. For example, a spatial light modulator (SLM), also known as a light valve (LV), is one type of light modulator that can be used to impress information equally across the entire beam (1D modulation), provide variation across the beam to form parallelized optical channels (2D modulation), or provide variations across a volume of pixels/voxels channels (3D modulation). The information imposed can be in the form of amplitude, phase, polarization, wavelength, coherency, or quantum entanglement. Industrial applications can require that LVs withstand high fluence and high energy laser sources for a prolonged period of time.

A light valve system includes a liquid crystal layer and one or more transparent electrodes positioned on one or more substrate layers, the substrate layers bracketing the liquid crystal layer. The transparent electrodes may be formed of a transparent conductive oxide, for example, Indium Tin Oxide (ITO). The one or more transparent electrodes can be applied using vapor deposition processes, epitaxial growth, or other complex industrial processes. Such processes increase the cost and complexity of production and can increase the risk of defects that can lead to defects in the patterning or light valve failure due to laser damage.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a prior art embodiment of a light valve system with a transparent conductive electrode film;

FIG. 1B illustrates a light valve system that includes a localized electrode contact on an electrically conductive region;

FIG. 2 illustrates an embodiment of a monolithic light valve system utilizing a transparent electrode;

FIG. 3A illustrates photoexcitation of a monolithic light valve system utilizing a transparent electrode;

FIG. 3B illustrates photoexcitation of a non-monolithic light valve system utilizing a transparent electrode;

FIG. 4 illustrates a particular additive manufacturing system;

FIG. 5 illustrates an additive manufacturing system;

FIG. 6 illustrates a method for operation of an additive manufacturing system able to direct one or two dimensional light; and

FIG. 7 illustrates an additive manufacturing system able to direct one or two dimensional light beams using a switchyard systems and allowing for measuring characteristics of new or recycled powder and fusing powder to form structures.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

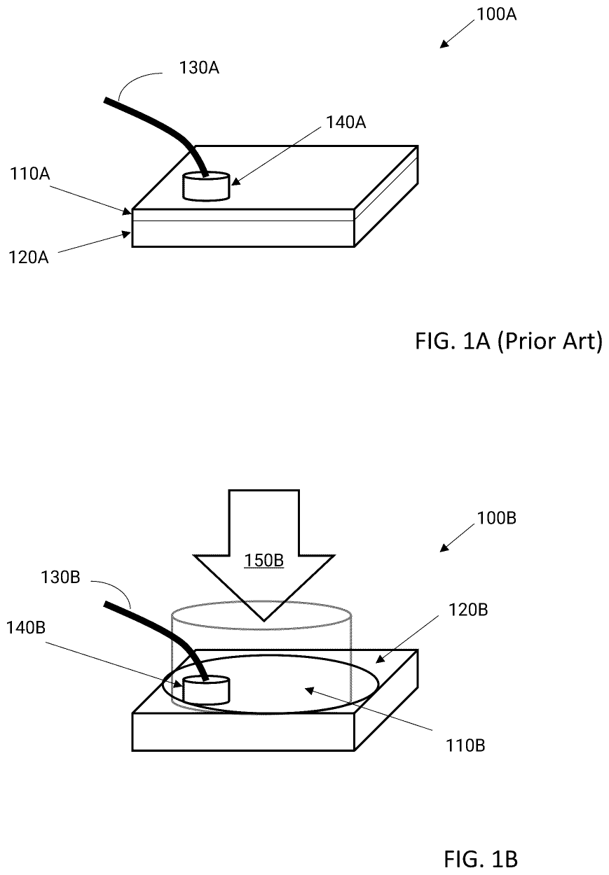

FIG. 1A illustrates a prior art embodiment of a light valve system 100A with a transparent conductive electrode film 110A positioned on semi-insulating band gap material 120A. Light reflective or transmissive properties of the semi-insulating band gap material 120A are modified by using an electric lead 130A that can apply a voltage to the transparent conductive electrode film 110A and the underlying semi-insulating band gap material 120A using an attached light blocking (opaque) electrode contact 140.

Such conventional transmissive light valve systems are useful for spatial light modification, patterning, or imaging. Such light valves are typically suitable for use in additive manufacturing systems or other application benefiting from long light valve lifetime when used at energy densities greater than 2 Joules/cm², kW levels of power, 10's of Joules energy over many cm² area. The light-induced electrically conductive layer can be dynamically optically addressed and can therefore be used to spatially pattern a field spreading layer that induces a locally confined field when a voltage bias is applied. Outside the area of illumination with the photoexciting light source, the material is insulating and no field is applied, yielding nearly perfect dark OFF state in the transmissive light valve system. A nearly perfect off state can be used to achieve superior contrast ratios when, for example, using a light valve in an additive manufacturing system to pattern laser light.

In contrast to the prior art embodiment, FIG. 1B illustrates a light valve system 100B that includes an electrically insulating dark region in a semi-insulating material 120B with light reflective or transmissive properties that are capable of being modified using the combination of a transparent electrode contact 140B connected to an electrical lead 130B and light addressing (indicated by arrow 150B and corresponding cylindrical light region directed against the semi-insulating material 120B). The transparent electrode contact 140B can be directly positioned on a “shallow” electrically conductive region 110B of the semi-insulating material 120B that has electrical conductivity induced by the addressing light of particular wavelengths, where depth (tL) and conductivity depend on λ and I 0<tL≤T. Typical materials include but are not limited to mid to wide bandgap photoconducting insulator materials such as high purity or doped compensated GaAs, InP, Ga₂O₃, SiC, AlN, GaN and others with near band edge (NBE) absorption depths of ˜0.1 μm for visible to UV wavelengths. At NBE excitation the generated electrical carriers can range from n=10¹⁷-10²³ carrier/cm³ depending on the illumination intensity (W/cm²), with electrical mobility, u, typical for such materials of 10-1000 cm²/(V·sec). The photoexcited layer resistivity is then proportional to both n and u under illumination In some embodiments the electrical contact to a voltage source bias to apply the field can be achieved via programmed narrow electrically active “illumination channels” that are too small to impact device performance. In other embodiments low intensity background illumination from a secondary source can be mixed with the patterning electrode light 150B, providing a conductive path from the contact 140B to the patterned light-induced electrically conductive region 110B with minimal field spreading in the background areas.

In operation, an addressing laser light creates a spatial pattern that can, in combination with polarizers, selectively block or transmit laser light passing through a laser light valve system. A high fluence, high power, and high energy input light can be directed to pass through the laser light valve system 100B, spatially patterned, and provide output light for various applications.

Advantageously, such a light valve system 100B does not need a transparent electrode applied via vapor deposition or epitaxial growth, making it possible to reduce the cost and process complexity and materials. Also eliminated are defects related delamination. Other advantages include increased tunable conductivity using light wavelength adjustments or intensity changes, increased charge mobility, and an ability to actively switch using optical illumination.

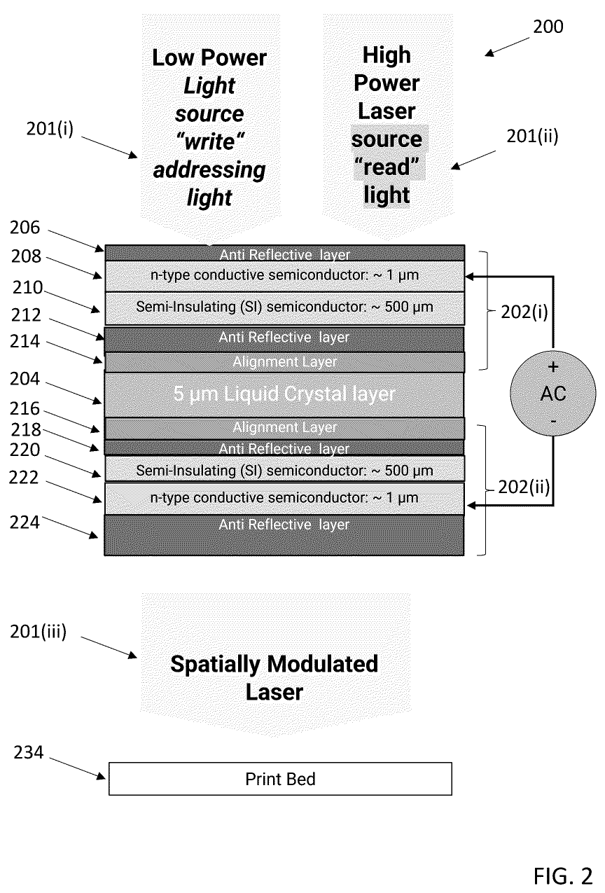

FIG. 2 illustrates an embodiment of a monolithic, high fluence, high power, and high energy transmissive light valve 200 that includes light patterning layer stacks 202(i) and 202(ii) that bracket or sandwich a liquid crystal 204. From top to bottom, layer 206 is an antireflective (AR) layer, layer 208 is a n-type conductive semiconductor produced, for example, by ion implantation or physical vapor deposition or epitaxial growth, and layer 210 is a photoconductive Semi-Insulating (SI) semiconductor. The semi-insulating semiconductor can be intrinsic or extrinsic (doped, compensated). Another antireflective layer 212 is stacked on an alignment layer 214. The alignment layer 214 grown or deposited on a 5 micron thick liquid crystal layer 204, completing the light patterning stack 202(i). Below the liquid crystal layer 204 is the second light patterning layer stack 202(ii) that includes an alignment layer 216 stacked on an antireflective layer 218. Next in the stack is a layer 220 formed by a Semi-Insulating (SI) semiconductor and a layer 222 formed by an n-type transparent conductive semiconductor. The second light patterning layer stack 202(ii) is completed by an antireflective layer 224.

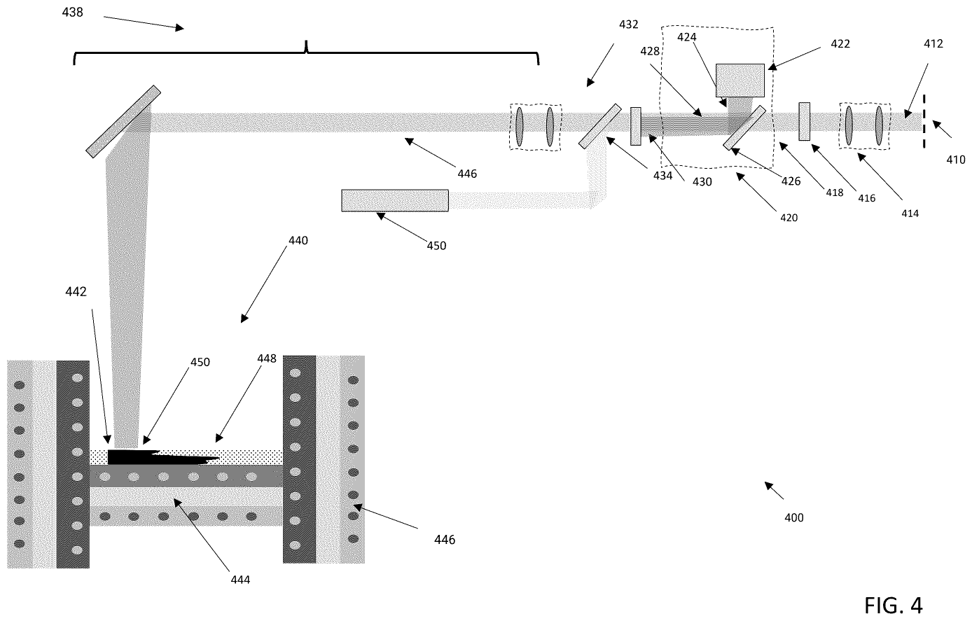

In operation, the n-type conductive semiconductor layers 210 and 222 are electrically connected to each other. An addressing (“write”) laser light 201 (i) creates a spatial pattern that selectively results in blocking or transmitting, or partially transmitting (“gray scaling”), the “read” laser light 201 (ii) passing through the light valve system 200. When the high fluence, high power, and high energy input read light 201 (ii) is directed to pass into the laser light valve system 200, it is spatially patterned, transmitted, and becomes the spatially patterned output light 201 (iii). This light can be directed to heat a powder print bed 234 suitable for additive manufacturing as later described with respect to FIGS. 4, 5, 6, and 7.

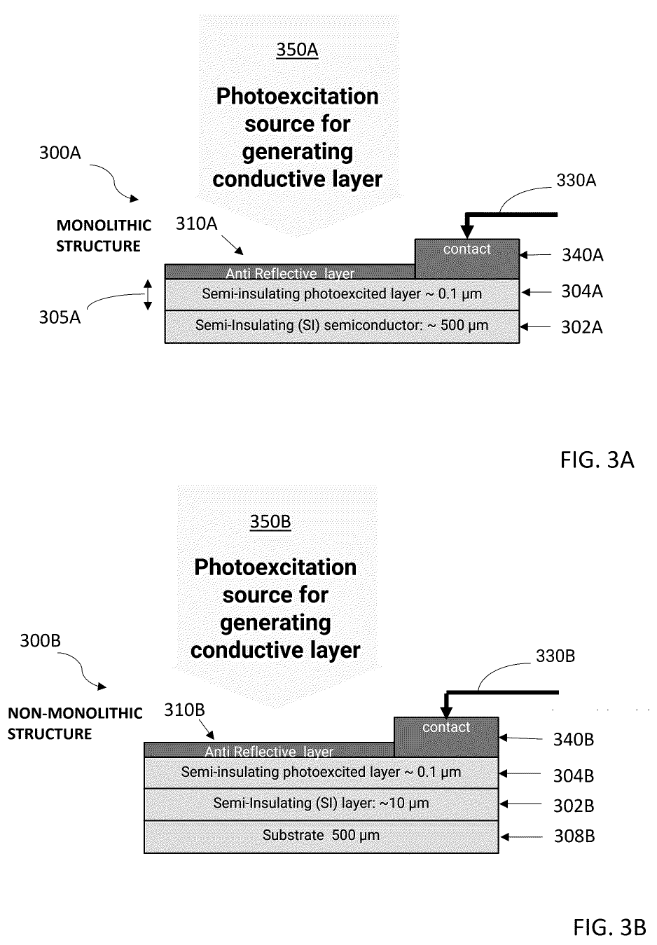

FIG. 3A illustrates another embodiment of a monolithic, high fluence transmissive light valve 300A similar to that previously described with respect to FIG. 2. However, in contrast to the embodiment of FIG. 2 which illustrates Semi-Insulating (SI) semiconductor layers 208 and 222 which are formed from an epitaxially grown n-epi material in order to form a transparent electrode, the light valve of FIG. 3A has the anti-reflective coating 310A applied directly to the semi-insulating semiconductor layer 302A.

Photoexcitation 350A of the semiconductor layer material 302A at an excitation wavelength near a band edge of semiconductor provides a transparent electrode 304A to the absorption depth 305A of the semiconductor layer 302A. Typical materials and values for the semi insulating semiconductor layer 302A range mid to wide bandgap and can include but are not limited to photoconducting insulator materials such as high purity or doped compensated GaAs, InP, Ga₂O₃, SiC, AlN, GaN and others with near band edge (NBE) absorption depths of ˜0.1 μm for visible to UV wavelengths. At NBE excitation the generated electrical carriers can range from n=10¹⁷-10²³ carrier/cm³ depending on the illumination intensity (W/cm²) with electrical mobility, u, typical for such materials of 10-1000 cm²/(V·sec). The photoexcited layer resistivity is then proportional to both n and u under illumination. A bias voltage is applied using electrical lead 330A and contact 340A across the transparent electrode 304A. When light from a photoexcitation source 350A is absorbed by the transparent electrode 304A the number of free electrons and holes increases, resulting in increased electrical conductivity. By controlling the light incident on the transparent electrode 304A, the charge in the transparent electrode 304A can be controlled, providing conducting regions and non-conducting “dark” regions.

FIG. 3B illustrates an embodiment of a non-monolithic high fluence transmissive light valve 300B similar to that previously described with respect to FIGS. 2 and 3A. However, in contrast to the embodiment of FIG. 2 which illustrates Semi-Insulating (SI) semiconductor layers 208 and 222 which are formed from an epitaxially grown n-epi material in order to form a transparent electrode, the light valve of FIG. 3B has the anti-reflective coating 310B applied directly to the semi-insulating semiconductor layer 302B. In contrast to the monolithic high fluence transmissive light valve described with reference to FIG. 3A, the non-monolithic high fluence transmissive light valve 300B further has an additional substrate layer 308B. This substrate layer 308B can be the same material or a different material as the semi-insulating semiconductor layer 302B.

Photoexcitation of this material provides a transparent electrode 304B to the absorption depth of the semiconductor layer. Typical materials and values for the semi insulating semiconductor layer 302B range mid to wide bandgap such as photoconducting insulator materials such as high purity or doped compensated GaAs, InP, Ga2O3, SiC, AlN, GaN and others with near band edge (NBE) absorption depths of ˜0.1 μm for visible to UV wavelengths. At NBE excitation the generated electrical carriers can range from n=1017-1023 carrier/cm3 depending on the illumination intensity (W/cm2) with electrical mobility, μ, typical for such materials of 10-1000 cm2/(V·sec). The photoexcited layer resistivity is then proportional to both n and u under illumination. A bias voltage is applied using electrical lead 330B and contact 340B across the transparent electrode 304B. When light from a photoexcitation source 350B is absorbed by the transparent electrode 304B the number of free electrons and holes increases, resulting in increased electrical conductivity. Similar to the monolithic light valve 300A of FIG. 3, by controlling the light incident on the transparent electrode 304B, the charge in the transparent electrode 304B can be controlled, providing conducting regions and non-conducting “dark” regions.

FIG. 4 is one embodiment of an additive manufacturing system 400. As seen in FIG. 4, one or more laser sources and amplifiers 410 can be constructed as a continuous or pulsed laser. The one or more laser sources and amplifiers can emit a red, or infra-red beam in various embodiments. The one or more laser sources and amplifier can comprise a heating laser or a high energy pulsed laser. In some examples a first beam line one or more laser sources and amplifiers 410 comprises a heating laser, for example one or more diode lasers or fiber lasers and a in a second beam line one or more laser sources and amplifiers 410 comprises a high energy pulsed laser. For example, the laser source can be a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulse source which uses a Pockels cell can be used to create an arbitrary length pulse train. Possible laser types include, but are not limited to: Gas Lasers, Chemical Lasers, Dye Lasers, Metal Vapor Lasers, Solid State Lasers (e.g. fiber), Semiconductor Lasers (e.g. diode), Free electron laser, Gas dynamic laser, “Nickel-like” Samarium laser, Raman laser, or Nuclear pumped laser. These lasers used different gain media, as noted and different ways of pumping the laser energy.

A Gas Laser can include lasers such as a Helium-neon laser, Argon laser, Krypton laser, Xenon ion laser, Nitrogen laser, Carbon dioxide laser, Carbon monoxide laser, or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate (Nd:YVO4) laser, Neodymium doped yttrium calcium oxoborateNd:YCa4O(BO3)3 or simply Nd:YCOB, Neodymium glass (Nd:Glass) laser, Titanium sapphire (Ti:sapphire) laser, Thulium YAG (Tm:YAG) laser, Ytterbium YAG (Yb:YAG) laser, Ytterbium:2O3 (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium) aluminum fluoride (Ce:LiSAF, Ce:LiCAF), Promethium 147 doped phosphate glass (147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride (Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

The beam 412 emitted from the one or more laser sources 410 can pass through a series of relay optics 414, said relay optics can comprise one or more lenses, mirrors, fibers or other systems capable of relaying laser energy. Said laser energy can then enter a laser homogenizer 416. Laser homogenizer 416 is configured to condition beam 412 to produce a more uniform beam profile. Laser homogenizer 416 may include one or more lenslet arrays or other systems to distribute energy across the beam profile. Laser homogenizer 416 may further include one or more optical systems to shape the beam, for example to produce a square beam.

A shaped beam 418 emitted from laser homogenizer 416 can subsequently enter a patterning unit assembly 420. A single beam line 418 is shown in FIG. 4, however one or more beam lines may enter the patterning unit assembly 420. In some examples, each beam line may enter a separate patterning assembly, in another embodiment each beam line may enter a single patterning unit assembly. Each beam line 418 can comprise a heating laser, a high power pulsed laser, patterning laser, or a combination thereof.

Patterning unit assembly 420 can include one or more projectors 422 emitting patterned blue light. For example, light with wavelength of 430-450 nm. The blue light emitter can be a DLP, LED, laser, or other digital projector arranged to emit patterned light in the blue spectrum. The blue light, in some embodiments, can be the same size and shape as the shaped beam 418. A beam combiner 426 can be used to combine the shaped laser light 418 from the one or more beam lines with the blue light 424, for example beam combiner 426 can transmit the shaped laser light 418 and reflect the blue light 424 to form a combined beam 428.

The combined beam 428 can enter a spatial light modulator (SLM) 430, e.g., a liquid crystal optically addressed light valve (“OALV”, “light valve”) that controls the polarization of the combined beam in a spatially varying manner. In other embodiments the light valve can control the phase or intensity variation of the combined beam or some combination of polarization, phase, and intensity. In alternative embodiments, fixed or variable masks or other equivalent methods of selectively blocking light may be used.

In an example, the light valve is formed of a sandwich of transparent substrates. The substrates can be bonded together at the edges, leaving a very small space (e.g. few micron space) between the substrates that is filled with liquid crystal. Several coatings can be applied to the substrate, for example anti-reflective coatings. The light valve may be a transmissive light valve or reflective light valve. The liquid crystal within the light valve activates when exposed to blue light, imparting a first polarization on areas of the combined beam 428 that contain blue light, and a second polarization on areas of the combined beam 428 that do not contain blue light. The light valve can withstand a high pulsed laser fluence and for example can be able to withstand a laser fluence of greater than 10 J/cm² for milliseconds for millions of laser pulses. The light valve can be able to switch between different pulses of patterned light at least 20 Hz, i.e., the liquid crystal can have a relaxation time of 50 milliseconds or less.

Polarized light 432 from the light valve enters a polarizer 434 which rejects the second polarized light. The polarizer 434 can transmit light of the first polarization and reflect light of the second polarization or vice versa. In various embodiments rejected light, not used in the pattern is directed toward a beam dump, light recycling system, or other light handling system.

Patterned energy 436 can relayed by one or more further relay optics 438 toward an article processing unit 440, in one embodiment, as a two-dimensional image 442 focused near a bed 444. In one embodiment, the patterned energy comprises a single pulse of high-power patterned laser energy. In another embodiment, the patterned energy can comprise a single pulse of patterned laser energy from a heating laser. In alternative embodiments, the patterned energy can comprise a combination of high-power patterned laser energy and patterned laser energy from a heating laser, where the high-powered patterned laser energy can have at least 10× the fluence of the patterned laser energy from the heating laser, and the pulse time of the heating laser is at least 10× the pulse time of the high power laser.

The article processing unit 440 can include a removable cartridge. The article processing unit 440 has plate or bed 444 with walls 446 that together form a sealed cartridge chamber containing material 448 (e.g. a metal powder, for example, metal powder my include alloys such as steels, Inconel, aluminum alloys, titanium alloys, or metal elements such as Iron, Copper, Aluminum, Titanium, etc.) dispensed by powder hopper or other material dispenser. Dispensed powder can be created or recycled as discussed in this disclosure. Patterned energy, directed by the image relay 436, can melt, fuse, sinter, amalgamate, change crystal structure, influence stress patterns, or otherwise chemically or physically modify the dispensed and distributed material 448 to form structures with desired properties. In various examples, 3-D objects can be formed by melting metal powder by the patterned energy in a sequential series of 2-D patterned areas “tiles” to form a first layer of melted metal, a further layer of metal powder can then be spread and a further sequential sequence of 2-D patterned tiles can be melted, repeating the spreading in melting until the object is formed. In some embodiments the tile may be the same pattern repeating for some or all of the print, in others the tile may not repeat. A control processor 450 can be connected to variety of sensors, actuators, heating or cooling systems, monitors, and controllers to coordinate operation of the laser source and amplifier(s) 410, relay optics 414, laser patterning assembly 420, and relay optics 438, as well as any other component of system 400. As will be appreciated, connections can be wired or wireless, continuous or intermittent, and include capability for feedback (for example, thermal heating can be adjusted in response to sensed temperature).

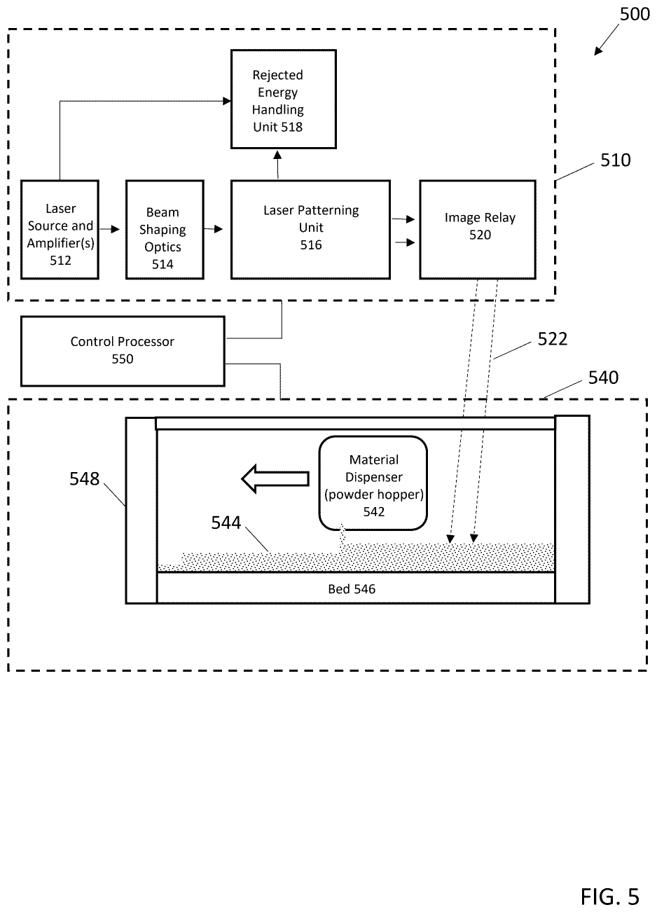

More generally, as illustrated in FIG. 5, an additive manufacturing system 500 uses lasers able to provide one- or two-dimensional directed energy as part of an that can be constructed as a continuous or pulsed laser. In some embodiments, the energy patterning system 510 can form one dimensional spatial patterning that can be directed as linear or curved strips, as rastered lines, as spiral lines, or in any other suitable form. Alternatively, two-dimensional patterning energy patterning can include directing beams that form separated or overlapping tiles, or images with variations in laser intensity. Two-dimensional spatial image patterns having non-square boundaries can be used, overlapping or interpenetrating images can be used, and images can be provided by two or more energy patterning systems. The energy patterning system 510 uses laser source and amplifier(s) 512 to direct one or more continuous or intermittent energy beam(s) toward beam shaping optics 514. After shaping, if necessary, the beam is patterned by an energy patterning unit 516, with generally some energy being directed to a rejected energy handling unit 518. Patterned energy is relayed by image relay 520 toward an article processing unit 540, in one embodiment as a two-dimensional image 522 focused near a bed 546. The article processing unit 540 can include a cartridge such as previously discussed. The article processing unit 540 has plate or bed 546 with walls 548 that together form a sealed cartridge chamber containing material 544 (e.g. a metal powder) dispensed by powder hopper or other material dispenser 542. Dispensed powder can be created or recycled as discussed in this disclosure. Patterned energy, directed by the image relay 520, can melt, fuse, sinter, amalgamate, change crystal structure, influence stress patterns, or otherwise chemically or physically modify the dispensed and distributed material 544 to form structures with desired properties. A control processor 550 can be connected to variety of sensors, actuators, heating or cooling systems, monitors, and controllers to coordinate operation of the laser source and amplifier(s) 512, beam shaping optics 514, laser patterning unit 516, and image relay 520, as well as any other component of system 500. As will be appreciated, connections can be wired or wireless, continuous or intermittent, and include capability for feedback (for example, thermal heating can be adjusted in response to sensed temperature).

In some embodiments, beam shaping optics 514 can include a great variety of imaging optics to combine, focus, diverge, reflect, refract, homogenize, adjust intensity, adjust frequency, or otherwise shape and direct one or more laser beams received from the laser source and amplifier(s) 512 toward the laser patterning unit 516. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 516 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, shields, or any other conventional system able to provide high intensity light patterning.

Rejected energy handling unit 518 is used to disperse, redirect, or utilize energy not patterned and passed through the image relay 520. In one embodiment, the rejected energy handling unit 518 can include passive or active cooling elements that remove heat from both the laser source and amplifier(s) 512 and the laser patterning unit 516. In other embodiments, the rejected energy handling unit can include a “beam dump” to absorb and convert to heat any beam energy not used in defining the laser pattern. In still other embodiments, rejected laser beam energy can be recycled using beam shaping optics 514. Alternatively, or in addition, rejected beam energy can be directed to the article processing unit 540 for heating or further patterning. In certain embodiments, rejected beam energy can be directed to additional energy patterning systems or article processing units.

Image relay 520 can receive a patterned image (either one or two-dimensional) from the laser patterning unit 516 directly or through a switchyard and guide it toward the article processing unit 540. In a manner similar to beam shaping optics 514, the image relay 520 can include optics to combine, focus, diverge, reflect, refract, adjust intensity, adjust frequency, or otherwise shape and direct the patterned light. Patterned light can be directed using movable mirrors, prisms, diffractive optical elements, or solid-state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 540 is substantially equivalent to the image distance. In effect, this enables a quick change in the optical beam delivery size and intensity across locations of a build area for different materials while ensuring high availability of the system.

The material dispenser 542 (e.g. powder hopper) in article processing unit 540 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposal or recycling by use of blowers, vacuum systems, sweeping, vibrating, shaking, tipping, or inversion of the bed 546.

In addition to material handling components, the article processing unit 540 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including but not limited to those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2, C₄H₇, 1,3-C₄H₆, 1,2-C₄H₆, C₅H₁₂, n-C₅H₁₂, i-C₅H₁₂, n-C₆H₁₄, C₂H₃C₁, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules, including but not limited to sulfur hexafluoride, can be used. An enclosure atmospheric composition having at least about 1% He by volume or number density, along with selected percentages of inert/non-reactive gases, can be used.

Control processor 550 can be connected to control any components of additive manufacturing system 500 described herein, including lasers, laser amplifiers, optics, heat control, build chambers, and manipulator devices. The control processor 550 can be connected to a variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 550 is provided with an interface to allow input of manufacturing instructions. Use of a wide range of sensors allows various feedback control mechanisms that improve quality, manufacturing throughput, and energy efficiency.

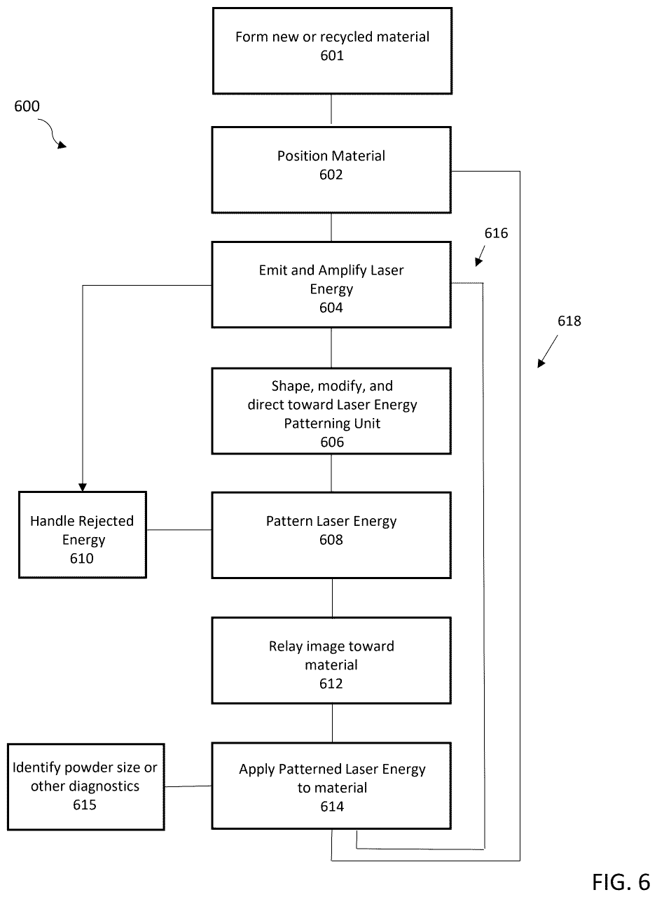

One embodiment of operation of a manufacturing system suitable for additive or subtractive manufacture is illustrated in FIG. 6. In this embodiment, a flow chart 600 illustrates one embodiment of a manufacturing process supported by the described optical and mechanical components and that includes use of various optical diagnostic systems such as previously described herein. In step 601, material powder created or recycled, as discussed in this disclosure, is formed. In step 602, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 604, unpatterned laser energy is emitted by one or more energy emitters, including but not limited to solid state or semiconductor lasers, and then amplified by one or more laser amplifiers. In step 606, the unpatterned laser energy is shaped and modified (e.g. intensity modulated or focused). In step 608, this unpatterned laser energy is patterned with energy not forming a part of the pattern being handled in step 610. This can include conversion to waste heat, recycling as patterned or unpatterned energy, or waste heat generated by cooling the laser amplifiers in step 604. In step 612, the patterned energy, now forming a one or two-dimensional image, is relayed toward the material. In step 614, the image is applied to the material either subtractively processing or additively building a portion of a 3D structure. In step 615, information derived from applying patterned laser energy to a material can be used to identify powder size or other need diagnostics or measurements. For additive manufacturing, these steps can be repeated, loop 618, until the image or different and subsequent image has been applied to all necessary regions of a top layer of the material. When application of energy to the top layer of the material is finished, a new layer can be applied, loop 616, to continue building the 3D structure. These process loops are continued until the 3D structure is complete, when remaining excess material can be removed or recycled.

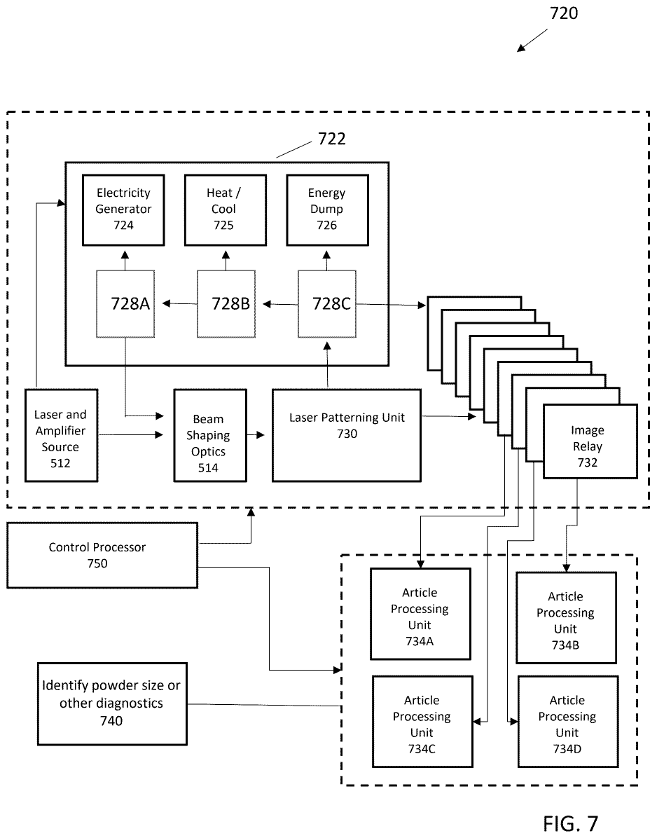

FIG. 7 is one embodiment of an additive manufacturing system that includes a phase change light valve and a switchyard system enabling reuse of patterned two-dimensional energy. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials. An additive manufacturing system 720 has an energy patterning system with a laser and amplifier source 712 that directs one or more continuous or intermittent laser beam(s) toward beam shaping optics 714. Excess heat can be transferred into a rejected energy handling unit 722 that can include an active light valve cooling system. After shaping, the beam is two-dimensionally patterned by an energy patterning unit 730, with generally some energy being directed to the rejected energy handling unit 722. Patterned energy is relayed by one of multiple image relays 732 toward one or more article processing units 734A, 734B, 734C, or 734D, typically as a two-dimensional image focused near a movable or fixed height bed. The bed is inside a cartridge that includes a powder hopper or similar material dispenser. Patterned laser beams, directed by the image relays 732, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 712 can be directed into one or more of an electricity generator 724, a heat/cool thermal management system 725, or an energy dump 726. Additionally, relays 728A, 728B, and 728C can respectively transfer energy to the electricity generator 724, the heat/cool thermal management system 725, or the energy dump 726. Optionally, relay 728C can direct patterned energy into the image relay 732 for further processing. In other embodiments, patterned energy can be directed by relay 728C, to relay 728B and 728A for insertion into the laser beam(s) provided by laser and amplifier source 712. Reuse of patterned images is also possible using image relay 732. Images can be redirected, inverted, mirrored, sub-patterned, or otherwise transformed for distribution to one or more article processing units 734A-D. Advantageously, reuse of the patterned light can improve energy efficiency of the additive manufacturing process, and in some cases improve energy intensity directed at a bed or reduce manufacture time. In some embodiments, information derived from applying patterned laser energy to material in one or more of the article processing units 734A-D can be used to identify powder size or other needed diagnostics or measurements using diagnostic module 740 and techniques and systems previously discussed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A light valve, comprising:
a semi-insulating material substrate having an electrically insulating dark region and a shallow electrically conductive region;
a transparent and conductive contact supported by the semi-insulating material substrate; and wherein
a charged carrier is generated optically in response to an incident light passing through the transparent and conductive contact and into the semi-insulating material substrate.

2. The light valve of claim 1, wherein a depth of the shallow electrically conductive region is less than a thickness of the semi-insulating material substrate.

3. The light valve of claim 1, further comprising a liquid crystal layer that contacts the semi-insulating material substrate.

4. The light valve of claim 1, further comprising a liquid crystal layer in bracketing contact with a first and a second semi-insulating material substrate.

5. The light valve of claim 1, wherein the transparent and conductive contact is a conductive oxide.

6. An additive manufacturing system, comprising:
a laser system for generating laser light; and
a light valve arranged to pattern laser light from the laser system, with the light valve having a tunable and reconfigurable transparent electrode that comprises a semi-insulating material substrate having an electrically insulating dark region and a shallow electrically conductive region, a transparent and conductive contact supported by the semi-insulating material substrate, and wherein a charged carrier is generated optically in response to an incident laser light passing through the transparent and conductive contact and into the semi-insulating material substrate.

7. The additive manufacturing system of claim 6, wherein a depth of the shallow electrically conductive region is less than a thickness of the semi-insulating material substrate.

8. The additive manufacturing system of claim 6, further comprising a liquid crystal layer that contacts the semi-insulating material substrate.

9. The additive manufacturing system of claim 6, further comprising a liquid crystal layer in bracketing contact with a first and a second semi-insulating material substrate.

10. The additive manufacturing system of claim 6, wherein the transparent and conductive contact is a conductive oxide.

11. A light valve, comprising:
a liquid crystal layer;
first and second semi-insulating semiconductor layers positioned respectively above and below the liquid crystal layer;
first and second n-type conductive layers positioned respectively in contact with the first and second semi-insulating semiconductor layers; and
wherein the first and second n-type conductive layers are electrically connected to each other.

12. The light valve of claim 11, further comprising at least one antireflective layer positioned above or below the liquid crystal layer.

13. The light valve of claim 11, wherein the light valve is addressable with a low power write addressing light.

14. The light valve of claim 11, wherein the light valve is addressable with a high power read addressing light.

15. The light valve of claim 11, wherein addressing the light valve with a low power write addressing light creates a spatial pattern that selectively results in at least one of blocking, transmitting, or partially transmitting a high power read addressing light.

16. An additive manufacturing system, comprising:
a laser system for generating a low power write addressing light and a high power read addressing laser light,
a light valve arranged to pattern light received from the laser system, with the light valve having a liquid crystal layer, first and second semi-insulating semiconductor layers positioned respectively above and below the liquid crystal layer, first and second n-type conductive layers positioned respectively in contact with the first and second semi-insulating semiconductor layers and wherein the first and second n-type conductive layers are electrically connected to each other.

17. The additive manufacturing system of claim 16, further comprising at least one antireflective layer positioned above or below the liquid crystal layer.

18. The additive manufacturing system of claim 16, further comprising at least one alignment layer positioned above or below the liquid crystal layer.

19. The additive manufacturing system of claim 16, wherein the low power write addressing light of the laser system creates a spatial pattern that selectively results in at least one of blocking, transmitting, or partially transmitting the high power read addressing light.
